(19) United States
(12) Patent Application Publication
(10) Pub. No.: US 2014/0216849 A1
(43) Pub. Date: Aug. 7, 2014

(54) COUPLING ASSEMBLY FOR WALKWAY IN PAVING MACHINE

(71) Applicant: Caterpillar Paving Products Inc., Brooklyn Park, MN (US)

(72) Inventor: Jacob R. Ellwein, Oak Grove, MN (US)

(73) Assignee: Caterpillar Paving Products Inc., Brooklyn Park, MN (US)

(21) Appl. No.: 14/250,999

(22) Filed: Apr. 11, 2014

(51) Int. Cl. B60R 3/00

(52) U.S. Cl. CPC B60R 3/00; E01C 2301/40
USPC 182/82

(57) ABSTRACT

A walkway assembly for a paving machine is provided. The paving machine includes a centering plate attached to a stairway, and a coupling assembly which couples the centering plate to a main walkway of the walkway assembly. The coupling assembly includes a bracket assembly, a first member, and a second member. The first member includes a first end with a first slot and the second member includes a second end with a second slot. A first disc and a second disc are in contact with a first surface and a second surface of the centering plate, respectively. The first disc includes a first recess to fit a first fastener end of a first fastener, allowing the first disc to pivot. The second disc includes a second recess to fit a second fastener end of a second fastener, allowing the second disc to pivot.

### TECHNICAL FIELD

The present disclosure relates generally to paving machines. More specifically, the present disclosure relates to a coupling assembly for attachment of a walkway assembly with the paving machine.

### BACKGROUND

Road construction equipment, such as paving machines, may be used for construction of road surfaces. Paving material, such as asphalt, may be laid, leveled and compacted on a paving surface. Asphalt may be added to the hopper of a paving machine by a dump truck, or other transfer vehicle. The asphalt may be transferred from the hopper to an asphalt feeder of the paving machine. The hopper may gravity feed an optimum pile of the asphalt over the asphalt feeder. The asphalt from the asphalt feeder may be transferred to a distributing auger. The distributing auger may lay the asphalt on the road bed as a stockpile in front of the screed. As the paving machine moves forward, the stockpile is generally flattened by a screed mounted on the rear end of the paving machine. The screed may compact the asphalt over the width of the paving surface. The screed of the paving machine may include a main screed, a first extender screed, and a second extender screed, positioned on either side of the main screed. The first extender screed and the second extender screed may extend or retract relative to the main screed. The screed is connected to a walkway assembly. The walkway assembly may include a main walkway, a first extender walkway, and a second extender walkway. The first extender walkway may be attached to the first extender screed. Similarly, the second extender walkway may be attached to the second screed. The main walkway may be slideably coupled with the first extender walkway and second extender walkway.

For a paving operation, there may be crowning of the screed. During the crowning, the main screed, the first extender screed, and the second extender screed may be adjusted or pivoted. For example, the first extender screed and the second extender screed may extend and pivot downwards or upwards for the paving operations. Hence, the first extender walkway and the second extender walkway may also pivot downwards or upwards, with respect to the first extender screed and the second extender screed. This may result in disengagement of the main walkway from the first extender walkway and the second extender walkway. For this purpose, a centering device is generally provided to center the main walkway during the paving operations. The centering device may be coupled to a centering plate, which may be attached to a stairway mounted on a body, or screed of the paving machine. The existing centering devices may also include rubber bumpers which are in contact with the centering plate. During the crowning, the rubber bumpers may be compressed to accommodate the motion of the first extender screed and the second extender screed. This may result in deflection or deformation of the rubber bumpers, when the rubber bumpers are compressed. Due to the deflection and sliding inability of the rubber bumpers, the above mentioned centering devices may deflect during the paving operations. Hence, this may lead to disengagement of the main walkway from the first extender walkway and the second extender walkway, making the existing centering devices incapable to accommodate motions of the screed during the paving operations. Also, this may lead to inefficient extension or retraction of the first extender walkway or/and the second extender walkway.

### SUMMARY OF THE DISCLOSURE

The present disclosure is related to a walkway assembly for a paving machine. The walkway assembly includes a stairway with a centering plate and a coupling assembly. The coupling assembly couples the centering plate to a main walkway of the walkway assembly.

According to the present disclosure, the coupling assembly includes a bracket assembly, a first disc, a second disc, a first fastener, and a second fastener. The bracket assembly includes a base plate attached to the main walkway, a first member extending from the base plate in a direction towards the stairway, and a second member extending from the base plate in the direction as that of the first member. Further, the first member includes a first end with a first slot and the second member includes a second end with a second slot.

The first disc and the second disc include a first recess and a second recess, respectively. Also, the first disc and the second disc are in contact with a first surface and a second surface of the centering plate, sandwiching the centering plate there between, respectively. The first fastener is secured in the first slot and includes a first fastener end. The first fastener end pivotally fits in the first recess, allowing the first disc to pivot. Similarly, the second fastener is secured in the second slot and includes a second fastener end. The second fastener end pivotally fits in the second recess, allowing the second disc to pivot.

### BRIEF DESCRIPTION OF THE DRAWINGS

FIG. 1 illustrates a side view of a paving machine, in accordance with the concepts of the present disclosure;

FIG. 2 illustrates a top view of a screed and a walkway assembly for use with the paving machine of FIG. 1, in accordance with the concepts of the present disclosure;

FIG. 3 illustrates a perspective view of the walkway assembly of FIG. 2 showing a stairway attached by a coupling assembly, in accordance with the concepts of the present disclosure;

FIG. 4 illustrates an exploded view of the coupling assembly of FIG. 3, in accordance with the concepts of the present disclosure; and

FIG. 5 illustrates a sectional view of the coupling assembly of FIG. 3, in accordance with the concepts of the present disclosure.

### DETAILED DESCRIPTION

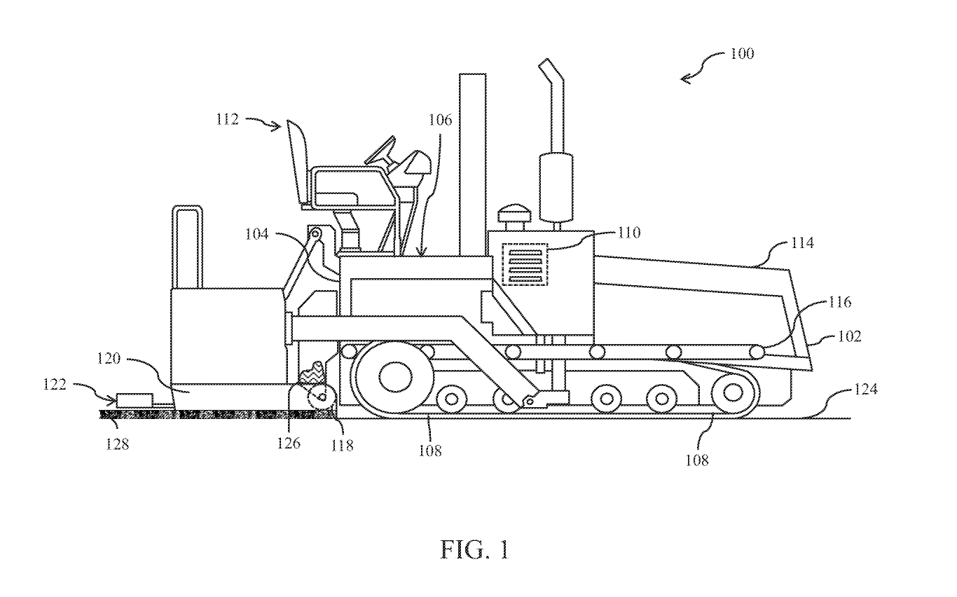

Referring to FIG. 1, shown is a paving machine 100, which may include a front end 102 and a rear end 104. The paving machine 100 may further include a superstructure 106, a pair of tracks 108, an engine 110, an operator station 112, a hopper 114, an asphalt feeder 116, a distributing auger 118, a screed 120, a walkway assembly 122, and a stairway (not shown). The superstructure 106 is supported on the pair of tracks 108. The pair of tracks 108 is driven by the engine 110, to propel the paving machine 100 on a surface, such as, a roadbed 124 on which asphalt is to be deposited. The engine 110 and the operator station 112 are mounted on the superstructure 106. The operator station 112 may house one or more user interfaces, to allow one or more operators to control various parameters for operation.

Further, the paving machine 100 includes the hopper 114, which may enable receiving of the asphalt from a dumping or transfer vehicle (not shown). The hopper 114 may gravity feed the received asphalt, to the asphalt feeder 116. The asphalt feeder 116 extends from the hopper 114 to the rear end 104 of the paving machine 100. In an embodiment, the asphalt feeder 116 may be a slat-type conveyor. The asphalt feeder 116 may allow conveyance of the asphalt to the distributing auger 118, through a feeder tunnel (not shown), under the superstructure 106 of the paving machine 100. The distributing auger 118 lays the asphalt over the roadbed 124, as a stockpile 126. In other words, the distributing auger 118 distributes the asphalt over the roadbed 124, at a location ahead of the screed 120.

Behind the distributing auger 118, the screed 120 may be disposed at the rear end 104 of the paving machine 100. The screed 120 may float over the stockpile 126, so as to smooth, compact, and level the stockpile 126 of the asphalt that has been laid on the roadbed 124. Thus, the screed 120 compacts the stockpile 126 of the asphalt into a mat, to create a smoothly paved surface 128.

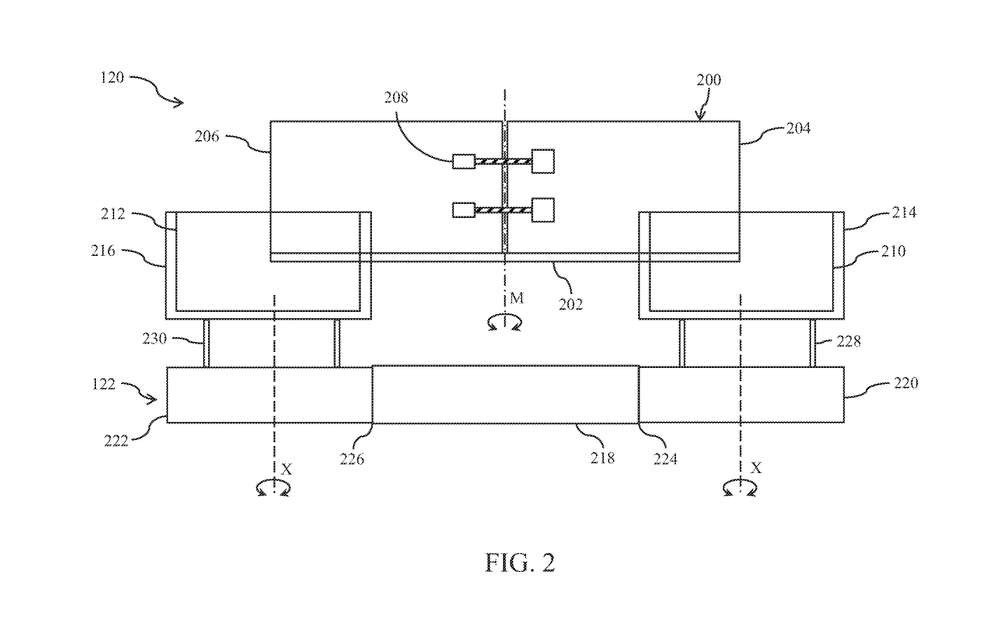

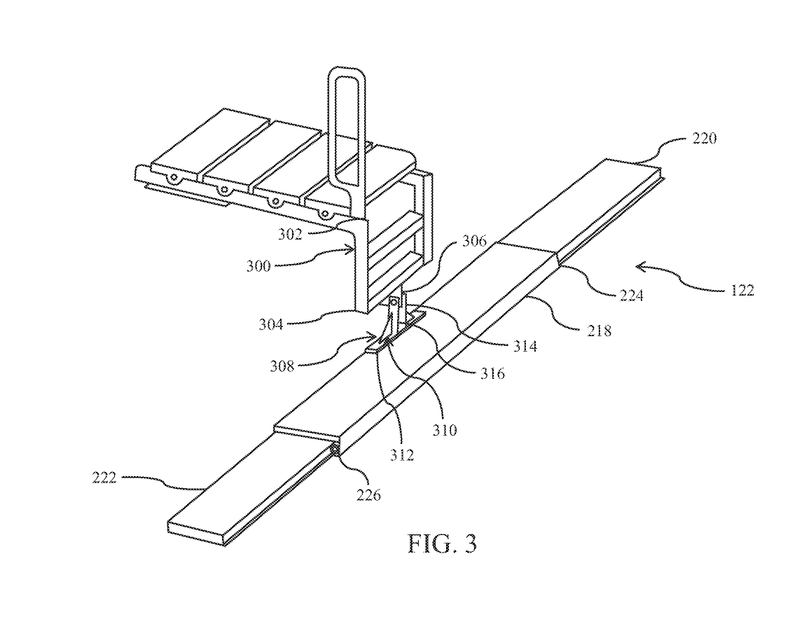

The paving machine 100 also includes the walkway assembly 122, attached to the screed 120. The walkway assembly 122 is located above the paved surface 128 such that there is no interference with the paving operation. The walkway assembly 122 may enable one or more operators to access one or more user interfaces (not shown). The operators may reach the walkway assembly 122 with the help of the stairway (as shown in FIG. 3), which may be mounted on the superstructure 106 or the screed 120. The walkway assembly 122 may enable the operators to observe the paving operation closely. The walkway assembly 122 is described in detail in reference to FIG. 2.

Referring to FIG. 2, there is shown a top view of the screed 120. The screed 120 includes a main screed 200. The main screed 200 may further include a main plate 202, a first section 204, a second section 206, and a pair of crown screws 208. The FIG. 2 is further described in conjunction with elements of FIG. 1.

The main plate 202 may be mounted on the first section 204 and the second section 206. The main plate 202 is used to level and compact the asphalt on the roadbed 124. The main plate 202 may be associated with one or more heating arrangements. The first section 204 and the second section 206 lie on either side of a center axis (not shown), of the main screed 200. The pair of crown screws 208 connect the first section 204 and the second section 206. The main screed 200 is pivotal about a pivot axis (M) by actuating the crown screws 208. The pivot axis (M) may lie on the center axis (not shown) of the main screed 200. In other words, each of the first section 204 and the second section 206 of the main screed 200, pivot about the pivot axis (M).

The first section 204 and the second section 206 of the main screed 200 can pivot about the pivot axis (M) when the crown screws 208 are actuated. The first section 204 and the second section 206 can be inclined at an angle (not shown), relative to each other. The aforementioned pivoting motion is known as crowning and the angle is called as crown angle. This allows the screed 120 to pave a variety of profiles of the paved surface 128. The crowning may be a positive crowning or a negative crowning. The positive crowning refers to pivot motion of the first section 204 or/and the second section 206, about the pivot axis (M), in a downward direction. Similarly, the negative crowning refers to the pivot motion of the first section 204 or/and the second section 206, about the pivot axis, (M), in an upward direction.

Referring to FIG. 2, the screed 120 includes a first extender screed 210 and a second extender screed 212. The first extender screed 210 and the second extender screed 212 may be mounted on either side of the main screed 200. The first extender screed 210 is mounted on the first section 204, and the second extender screed 212 is mounted on the second section 206. The first extender screed 210 and the second extender screed 212, respectively, include a first extender plate 214 and a second extender plate 216. The first extender plate 214 and the second extender plate 216 are respectively mounted on the first extender screed 210 and the second extender screed 212. Each of the first extender plate 214 and the second extender plate 216 may compact and level the asphalt on the roadbed 124.

The first extender screed 210 and the second extender screed 212 may respectively retract-and-extend, relative to the first section 204, and the second section 206. Also, the first extender screed 210 and the second extender screed 212 are able to pivot about an axis (X), relative to the first section 204 and the second section 206. The angle between the first extender screed 210 and the first section 204, or the angle between the second extender screed 212 and the second section 206, is referred to as slope angle (not shown). The slope angle (not shown) corresponds to the sloping of the first extender screed 210 and the second extender screed 212. However, it is envisioned that the first extender screed 210 and the second extender screed 212 may attain other configurations, known to those with ordinary skill in the art, to pave differently shaped paving surfaces.

The walkway assembly 122 includes a main walkway 218, a first extender walkway 220, and a second extender walkway 222. The main walkway 218 includes a first lateral end 224 and a second lateral end 226, to respectively, receive the first extender walkway 220 and the second extender walkway 222. The first extender walkway 220 and the second extender walkway 222 are slidably connected to the main walkway 218. The first extender walkway 220 is coupled to the first extender screed 210, by a first walkway mount 228. Similarly, the second extender walkway 222 is coupled to the second extender screed 212, by a second walkway mount 230. The first extender walkway 220 and the second extender walkway 222 are extendable and retractable in a horizontal direction, relative to the main walkway 218. The extension, retraction, and pivoting of the first extender walkway 220 and the second extender walkway 222, respectively, correspond to the extension, retraction, and pivoting of the first extender screed 210, and the second extender screed 212. Therefore, in a fully retracted configuration of the screed 120, the first extender walkway 220 and the second extender walkway 222 are fully retracted within the main walkway 218. Similarly, the first extender walkway 220 and the second extender walkway 222, are extended in outward position relative to the main walkway 218. It is to be noted that even in the extended outward position, the first extender walkway 220 and the second extender walkway 222 overlap with the main walkway 218 and continue to engage with main walkway 218.

Referring to FIG. 3, the stairway 300 may be mounted on the superstructure 106, or the screed 120 of the paving machine 100 of FIG. 1. FIG. 3 is further described in conjunction with elements of FIG. 1 and FIG. 2.

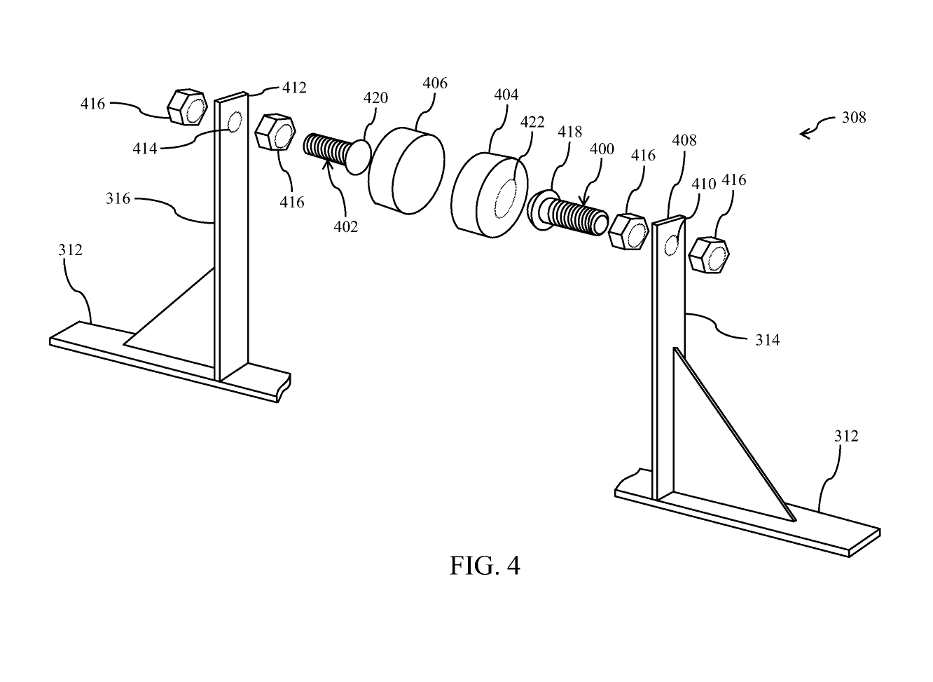

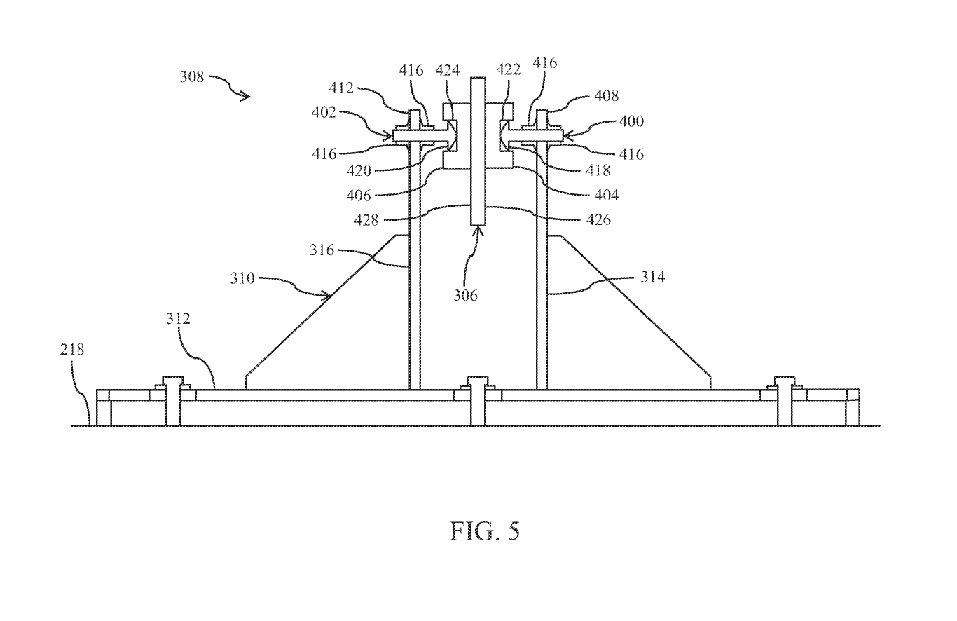

The stairway 300 may allow the one or more operators to access the walkway assembly 122. The stairway 300 has a first stairway end 302 and a second stairway end 304. The first stairway end 302 is distal to the walkway assembly 122, and the second stairway end 304 is proximal to the walkway assembly 122. The stairway 300 includes a centering plate 306, which is vertically aligned and attached to the second stairway end 304. A lower end of the centering plate 306 is clamped by a coupling assembly 308. The coupling assembly 308 enables coupling of the centering plate 306 to the walkway assembly 122. The coupling assembly 308 may be attached to the main walkway 218 of the walkway assembly 122. The interaction between the centering plate 306 and the coupling assembly 308 of FIG. 3 is further described in conjunction with elements of FIG. 4 and FIG. 5.

Referring to FIG. 4 and FIG. 5, the coupling assembly 308 includes a bracket assembly 310, a first fastener 400, a second fastener 402, a first disc 404, and a second disc 406. The bracket assembly 310 includes a base plate 312, a first member 314, and a second member 316. The base plate 312 may be attached to the main walkway 218 of the walkway assembly 122. In an exemplary embodiment, the base plate 312 may be attached to the main walkway 218 by welds, screws, or any other fastening or joining arrangement. The first member 314 extends from the base plate 312, in a direction towards the stairway 300 (FIG. 3). Similarly, the second member 316 extends from the base plate 312, in the direction as that of the first member 314. The first member 314 has a first end 408, which is distal to the base plate 312. The first end 408 of the first member 314 includes a first slot 410. Similarly, the second member 316 has a second end 412, which is distal to the base plate 312. The second end 412 of the second member 316 includes a second slot 414. However, it is envisioned that other shapes, sizes, and geometries of the first slot 410 and the second slot 414, known to those with ordinary skill may be contemplated.

Referring to FIG. 4 and FIG. 5, the first fastener 400 is secured in the first slot 410 by a nut arrangement 416, on each side of the first member 314. Although not shown, one or more washers may be used with the nut arrangement 416. The first fastener 400 is secured in the first slot 410, such that a first fastener end 418 of the first fastener 400 is towards the second member 316.

Similarly, the second fastener 402 is secured in the second slot 414 by the nut arrangement 416, on each side of the second member 316. Although not shown, one or more washers may be used with the nut arrangement 416. The second fastener 402 is secured in the second slot 414, such that a second fastener end 420 of the second fastener 402 is pointing towards the first member 314. In an embodiment, each of the first fastener 400 and the second fastener 402 may be a nut, a screw, a pin, a threaded fastener, or other similar fastening element known in the art. The first fastener 400 and the second fastener 402 may be carriage bolts which have curved surface heads. The curved heads may be referred to as the first fastener end 418 and second fastener end 420. The first fastener end 418 and the second fastener end 420 are movably coupled with the first disc 404 and the second disc 406.

The first fastener 400 with the first disc 404 and the second fastener 402 with the second disc 406, respectively, is secured on the first member 314 and second member 316, clamping the centering plate 306 in between. Securing of the first fastener 400 in the first slot 410, with the nut arrangement 416, on each side of the first member 314, allows adjustment of the distance, by which the first fastener 400 moves towards or away from the second member 316 or the centering plate 306. This adjustment may enable calibration and adjustment of the first disc 404, with which the first fastener end 418 of the first fastener 400 is attached. Similarly, securing of the second fastener 402 in the second slot 414 with the nut arrangement 416, on each side of the second member 316, allows adjustment of the distance, by which the second fastener 402 moves towards or away from the first member 314 or the centering plate 306. This adjustment may enable calibration and adjustment of the second disc 406, with which the second fastener end 420 of the second fastener 402 is attached. The above mentioned arrangement of the first fastener 400 and the second fastener 402, respectively, calibrates the first disc 404 and the second disc 406.

Abrasion resistant polymer, plastic or any other material known to those having ordinary skill in the art can be used for the first disc 404 and the second disc 406. The first disc 404 and the second disc 406, respectively, are pivotally attached to the first fastener end 418 and the second fastener end 420. The first disc 404 and the second disc 406, respectively, include a first recess 422 and a second recess 424 (as shown in FIG. 5). In an embodiment, each of the first recess 422 and the second recess 424 may be a conically drilled recess or a flat bottom recess which ever provides suitable pivotal performance and is cost effective to manufacture. In one embodiment, the first recess 422 and the second recess 424 can be a flat, conical, spherical, parabolic or any other shape known to those having ordinary skill in the art can be used for the shape of the recess.

As discussed above, the first disc 404 is pivotally attached to the first fastener 400. This is achieved by having the first fastener end 418 be movably retained in the first recess 422, similar to movable connections, one of which may be best described as a cup and ball arrangement. This allows the first disc 404 to pivot. Also, the first disc 404 is in contact with a first surface 426 (as shown in FIG. 5) of the centering plate 306. The first disc 404 slides on the first surface 426 of the centering plate 306, during the paving operations.

The second disc 406 includes the second recess 424. The second disc 406 is pivotally attached to the second fastener 402, similar to attachment of the first disc 404 to the first fastener 400. This is achieved by pivotally fitting the second fastener end 420 in the second recess 424, which allows the second disc 406 to pivot. Also, the second disc 406 is in contact with a second surface 428 (as shown in FIG. 5) of the centering plate 306. The second disc 406 slides on the second surface 428 of the centering plate 306, during the paving operations. In other words, the centering plate 306 is clamped between the first disc 404 and the second disc 406, so as to enable the first disc 404 and the second disc 406, respectively, to sandwich the centering plate 306, contemporaneously allowing the centering plate 306 to slide on the first disc 404 and the second disc 406, during crowning and other settling events for the walkway assembly 122.

Further, the compactness, with which the first disc 404 and the second disc 406 are in contact with the centering plate 306 can be calibrated, based on the adjustment of the first fastener 400 and the second fastener 402 with the help of the nut arrangement 416. Hence, the location and movement of the main walkway 218 can be accommodated by adjusting clamping force, based on the compactness of the first disc 404 and the second disc 406 with the centering plate 306. Also, with prolonged use, the first disc 404 and the second disc 406 may undergo wear, and thereby, affect the compactness with which the first disc 404 and the second disc 406 are in contact with the centering plate 306. Thus, the above mentioned adjustment of the first fastener 400 and the second fastener 402, optimally maintains the compactness of the first disc 404 and the second disc 406, respectively, with the centering plate 306.

### INDUSTRIAL APPLICABILITY

In the present disclosure, the coupling assembly 308 attaches the centering plate 306 to the main walkway 218 of the walkway assembly 122. In operation, the screed 120 of the paving machine 100 may crown during a paving operation. During crowning, at least one of the first extender screed 210 and the second extender screed 212 may extend away from the main screed 200, and may also pivot in an upward direction or a downward direction. For example, when the first extender screed 210 extends outwardly and away from the main screed 200, the first extender walkway 220 also extends in correspondence to the first extender screed 210. Also, the first extender walkway 220 pivots in the downward direction or the upward direction, in correspondence to the first extender screed 210. The first extender walkway 220 pivots relative to the main walkway 218, which is maintained at a center of the walkway assembly 122. This may result in deflection of the main walkway 218 from the center of the walkway assembly 122. The disclosed coupling assembly 308 aids in keeping the main walkway 218 centered, and allow the screed 120 to travel through its various crowning motions, without binding or excessive deflection. Further, during paving operations, the coupling assembly 308 enhances the engagement of the main walkway 218 with the first extender walkway 220 and the second extender walkway 222, during the crowning motion. The disclosed coupling assembly 308 includes the first disc 404 and the second disc 406, which slide on the centering plate 306, to prevent deflection of the main walkway 218. The first disc 404 and the second disc 406 slide freely on both sides of the centering plate 306, to counter the deflection of the main walkway 218. This may also aid in achieving efficient extension or/and retraction of the first extender walkway 220 and the second extender walkway 222, during the crowning operation. Hence, the pivoting capacity of the first disc 404 and the second disc 406 of the disclosed coupling assembly 308, allows accommodation of all the motions of the screed 120 during the paving operations. Also, the coupling assembly 308 is more durable due to reduced tendency to deflect or deform, as compared to the existing devices serving the same purpose in the paving machines.

Also, the first fastener 400 and the second fastener 402 are moved to and fro, respectively, within the first slot 410 and the second slot 414. Movement of the first fastener 400 and the second fastener 402, respectively, calibrates the compactness of the first disc 404 and the second disc 406 with the centering plate 306. Further, the calibration of the first disc 404 or/and the second disc 406 is beneficial, when the first disc 404 or/and the second disc 406 become worn-out due to prolonged use. Hence, the disclosed coupling assembly 308 is cost-effective.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A walkway assembly for a paving machine including a stairway having a centering plate and a coupling assembly configured to couple the centering plate to a main walkway of the walkway assembly, the coupling assembly comprising:
a bracket assembly attached to the main walkway, the bracket assembly including:
a base plate attached to the main walkway;
a first member extending from the base plate in a direction towards the stairway, the first member having a first end distal to the base plate, the first end includes a first slot; and
a second member extending from the base plate in the direction as that of the first member, the second member having a second end distal to the base plate, the second end includes a second slot;
a first disc includes a first recess, the first disc is in contact with a first surface of the centering plate and is configured to slide on the centering plate;
a second disc includes a second recess, the second disc is in contact with a second surface of the centering plate and is configured to slide on the centering plate;
a first fastener is secured into the first slot of the first member, the first fastener includes a first fastener end configured to pivotably fit in the first recess of the first disc, allowing the first disc to pivot; and
a second fastener is secured into the second slot of the second member, the second fastener includes a second fastener end configured to pivotably fit in the second recess of the second disc, allowing the second disc to pivot.
